(19) United States
(12) Patent Application Publication
(10) Pub. No.: US 2025/0075653 A1
(43) Pub. Date: Mar. 6, 2025

(54) COOLING SYSTEM OF AGRICULTURAL WORK VEHICLE

(71) Applicant: Daedong Corporation, Dalsung-Gun (KR)

(72) Inventor: Hun Jung LEE, Changnyeong-gun (KR)

(73) Assignee: Daedong Corporation, Dalsung-Gun (KR)

(21) Appl. No.: 18/459,017

(22) Filed: Aug. 30, 2023

(51) Int. Cl. F01P 5/06; B60K 11/04

(52) U.S. Cl. CPC F01P 5/06; B60K 11/04; F28F 2280/105

(57) ABSTRACT

A cooling system of an agricultural work vehicle includes a cooling unit including a radiator and configured to perform cooling operation, and a coupling unit rotatably coupling the cooling unit to an inner side wall of an engine room. The coupling unit comprises a hinge part provided on a first side surface of the cooling unit and rotatably coupled to a first inner side wall of the engine room; and a locking part provided on a second side surface of the cooling unit and separably coupled to a second inner side wall of the engine room, wherein when the locking part is separated from the second inner side wall of the engine room, the cooling unit is rotatable on the hinge part.

### BACKGROUND OF THE INVENTION

### Field of the Invention

The present disclosure relates to a cooling system of an agricultural work vehicle and, more particularly, to a cooling system of an agricultural work vehicle, the cooling system being installed inside an engine room to be rotatable in one direction.

### Description of the Related Art

Inside an engine room of an agricultural work vehicle, an engine, various mechanical devices, and various electronic devices are mounted. However, since the internal volume of the engine room is limited, it is essential to design and arrange the components by comprehensively considering not only ease of assembly but also maintenance methods.

Meanwhile, in conventional agricultural work vehicles, it is common that a cooling system including a radiator, an intercooler, an oil cooler, etc. is securely installed in front of the engine. Therefore, even when expendable supplies such as oil filters are replaced or simple maintenance is performed, the cooling system separation work must proceed, which increases cost and time required for maintenance.

Furthermore, since a cooling system having wide sectional area blocks a front surface of the engine room, in a state where the cooling system is mounted, it is difficult to clean the inside space of the engine room difficult.

### SUMMARY OF THE INVENTION

An objective of the present disclosure is intended to provide a cooling system which is rotatable in one direction inside an engine room so that components located behind the cooling system can be easily exposed without disassembling the cooling system.

However, the problem to be solved by the present disclosure is not limited to the above-described problem, and may expand in various ways within a range that does not deviate from the spirit and scope of the present disclosure.

In order to achieve the above-described objectives of the present disclosure, there is provided a cooling system of an agricultural work vehicle, the cooling system including: a cooling unit including a radiator and configured to perform cooling operation; and a coupling unit rotatably coupling the cooling unit to an inner side wall of an engine room.

The coupling unit may include: a hinge part provided on a first side surface of the cooling unit and rotatably coupled to a first inner side wall of the engine room; and a locking part provided on a second side surface of the cooling unit and separably coupled to a second inner side wall of the engine room, wherein when the locking part is separated from the second inner side wall of the engine room, the cooling unit may be rotatable on the hinge part.

The hinge part may limit a rotation range of the cooling unit within a preset angular range.

The locking part may be separably coupled to the second inner side wall of the engine room by using a magnet.

The cooling system may include: a shroud configured to guide air introduced into the cooling unit towards a cooling fan, wherein the shroud may include: a body part configured to induce the air passing through the cooling unit towards the cooling fan; and a guide part protruding along an outer circumferential surface of the body part and forming a space in which a part of the cooling fan is received.

A gap between the guide part and the cooling fan in a direction of the first side surface of the cooling unit may be provided larger than a gap between the guide part and the cooling fan in a direction of the second side surface of the cooling unit.

The cooling system may include: a hose configured to supply the heated engine coolant to the radiator, wherein the hose may be connected to the radiator in a direction of the first side surface of the cooling unit.

A last end of the hose connected to the radiator may be made of a flexible material.

A cooling system of an agricultural work vehicle may include: a cooling unit configured to cool an engine coolant and engine oil that are heated in an engine; a hinge part provided at a first portion of the cooling unit and rotatably coupled to an inner side wall of the engine room; a locking part provided at a second portion of the cooling unit and separably coupled to the inner side wall of the engine room; and a hose delivering the engine coolant and the engine oil that are heated in the engine to the cooling unit, and returning the engine coolant and the engine oil cooled in the cooling unit to the engine, wherein the hose may be connected to the cooling unit in a direction of the first portion of the cooling unit where the hinge part may be provided.

A cooling system of an agricultural work vehicle may include: a cooling unit configured to cool an engine coolant and engine oil that are heated in an engine; a hinge part provided at a first portion of the cooling unit and rotatably coupled to an inner side wall of the engine room; a locking part provided at a second portion of the cooling unit and separably coupled to the inner side wall of the engine room; and a shroud provided between the cooling unit and a cooling fan to induce a flow of air, and in which a part of the cooling fan is received, wherein a gap between the shroud and the cooling fan received in the shroud in a direction of the first portion of the cooling unit where the hinge part is provided may be larger than a gap between the shroud and the cooling fan received therein in a direction of the second portion of the cooling unit where the locking part is provided.

The cooling system of an agricultural work vehicle according to the exemplary embodiments of the present disclosure has the cooling unit rotatably installed inside the engine room. Therefore, in case of necessity, components located behind the cooling unit can be easily repaired and replaced by rotating the cooling unit, and cleaning of the internal space of the engine room can be further easily performed.

### BRIEF DESCRIPTION OF THE DRAWINGS

FIG. 1 is a side view showing a general agricultural work vehicle.

FIG. 2 is a front view showing an engine room of FIG. 1.

FIGS. 3A and 3B are plan views showing operational states of a cooling system according to the present disclosure.

FIGS. 4A and 4B are views showing relation of arrangement between the cooling system and a fan in FIGS. 3A and 3B.

FIG. 5 is a view showing relation of connection between the cooling system and a hose in FIGS. 3A and 3B.

### DETAILED DESCRIPTION OF THE DISCLOSURE

In the following description, the structural or functional description specified to exemplary embodiments according to the concept of the present disclosure is intended to describe the exemplary embodiments, so it should be understood that the present disclosure may be variously embodied, without being limited to the exemplary embodiments.

The exemplary embodiments according to the concept of the present disclosure may be variously modified and may have various shapes, so examples of which are illustrated in the accompanying drawings and will be described in detail with reference to the accompanying drawings. However, it should be understood that the exemplary embodiments according to the concept of the present disclosure are not limited to the embodiments which will be described hereinbelow with reference to the accompanying drawings, but various modifications, equivalents, additions and substitutions are possible, without departing from the scope and spirit of the invention.

It will be understood that, although the terms first, second, etc. may be used herein to describe various elements, these elements should not be limited by these terms. These terms are only used to distinguish one element, from another element. For instance, a first element discussed below could be termed a second element without departing from the teachings of the present disclosure. Similarly, the second element could also be termed the first element.

It will be understood that when an element is referred to as being “coupled” or “connected” to another element, it can be directly coupled or connected to the other element or intervening elements may be present therebetween.

In contrast, it should be understood that when an element is referred to as being “directly coupled” or “directly connected” to another element, there are no intervening elements present. Further, the terms used herein to describe a relationship between elements, for example, “between”, “directly between”, “adjacent” or “directly adjacent” should be interpreted in the same manner as those described above.

The terminology used herein is for the purpose of describing particular embodiments only and is not intended to be limiting. As used herein, the singular forms “a”, “an”, and “the” are intended to include the plural forms as well, unless the context clearly indicates otherwise.

It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Unless otherwise defined, all terms including technical and scientific terms used herein have the same meaning as commonly understood by one of ordinary skill in the art to which this invention belongs.

It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinbelow, an exemplary embodiment of the present disclosure will be described in detail with reference to accompanying drawings. The same reference numerals denote components having the same or similar function throughout the drawings, and detailed description thereof will be omitted.

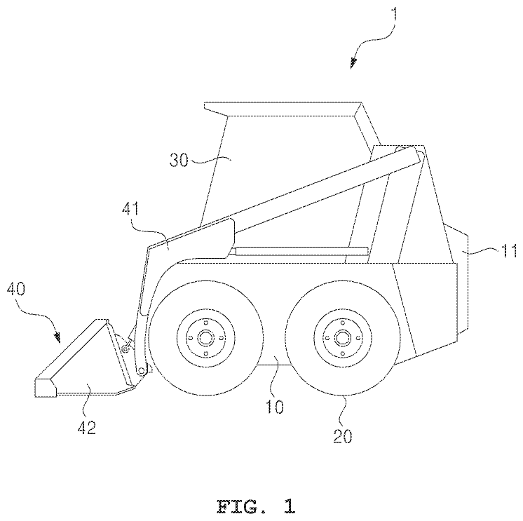

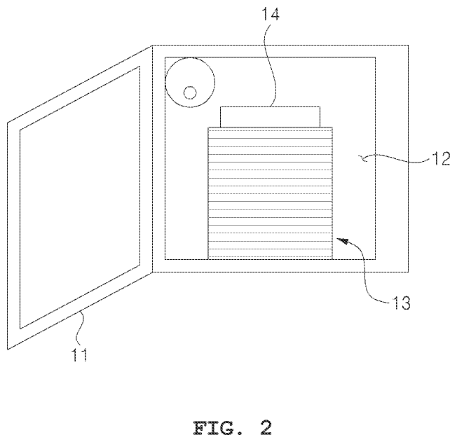

FIG. 1 is a side view showing a general agricultural work vehicle. FIG. 2 is a front view showing the engine room of FIG. 1.

The agricultural work vehicle may mean vehicles such as a tractor, a combine, a skid loader, etc. that are equipped with a cooling system in an engine room. In other words, the present disclosure relates to a cooling system rotatably mounted, and may be applied to vehicles in the same or similar method if the vehicles are equipped with the cooling system. However, for the convenience of description, the present disclosure will be described for a skid loader as an example.

The skid loader is a work vehicle used to move shapeless objects such as dirt or sand or stack the objects high, and is mostly used in a work site narrow in radius because the skid loader is 360-degree rotatable in place.

As shown in FIG. 1, the skid loader 1 may include a vehicle body 10, wheels 20 supporting and moving the vehicle body 10, an operator room 30 installed on the vehicle body 10 to provide an operating space for an operator, and an operating device 40 provided at the vehicle body 10.

The vehicle body 10 may include an engine room 12 in which an engine is mounted, various hydraulic cylinders, and the like. At this point, the engine room 12 may be provided in an engine room cover 11 located behind the vehicle body 10.

The wheels 20 may support the vehicle body 10 and the operator room 30, and may drive the skid loader 1 by using power generated from the engine.

The operator room 30 is installed on the vehicle body 10, and a driver can operate the skid loader 1 while entering the inside space thereof. Various operating devices for driving the vehicle and operating the operating device 40 may be provided in the operator room 30.

The operating device 40 may include a boom 41 connected to the vehicle body 10, and an attachment 42 connected to the boom 41. The attachment may include a bucket, a crusher, a breaker, a snow blade, and the like. FIG. 1 is a view showing the skid loader 1 to which a bucket is mounted. The operating device 40 may be driven by a pressure of a hydraulic fluid, the pressure being generated from a hydraulic pump.

Meanwhile, the engine room 12 may be provided in the engine room cover 11. As shown in FIG. 2, when the engine room cover 11 is opened, a cooling system 13 including a radiator is securely installed at a front surface of an engine 14. Therefore, a work of disassembling the cooling system 13 should be preceded for replacement of expendable supplies such as oil filters or maintenance of the engine 14. Therefore, despite the relatively simple maintenance, the time and cost required for the maintenance work due to the presence of the cooling system 13.

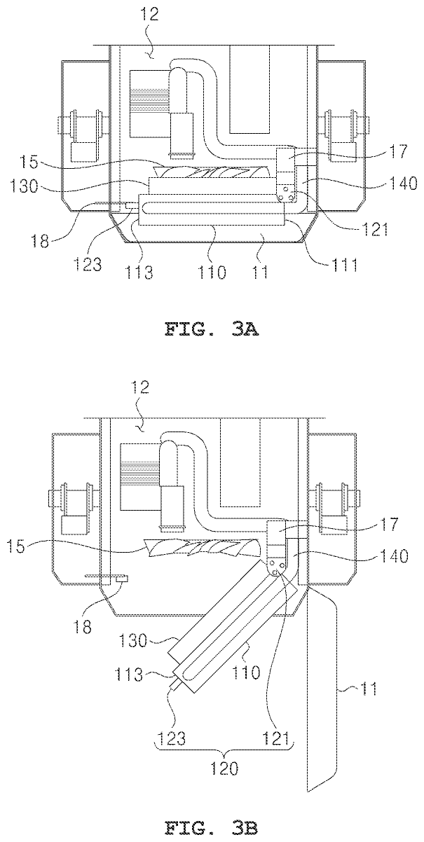

The present disclosure was devised to solve the above problems, and the present disclosure is characterized in that the cooling system is rotatably mounted to the engine room. Therefore, without disassembling the cooling system, parts located in the cooling system can be exposed with simple manipulation. Accordingly, maintenance and cleaning of the vehicle can be easily performed. Hereinbelow, the cooling system of an agricultural work vehicle according to the present disclosure will be described in detail with reference to FIGS. 3 to 5.

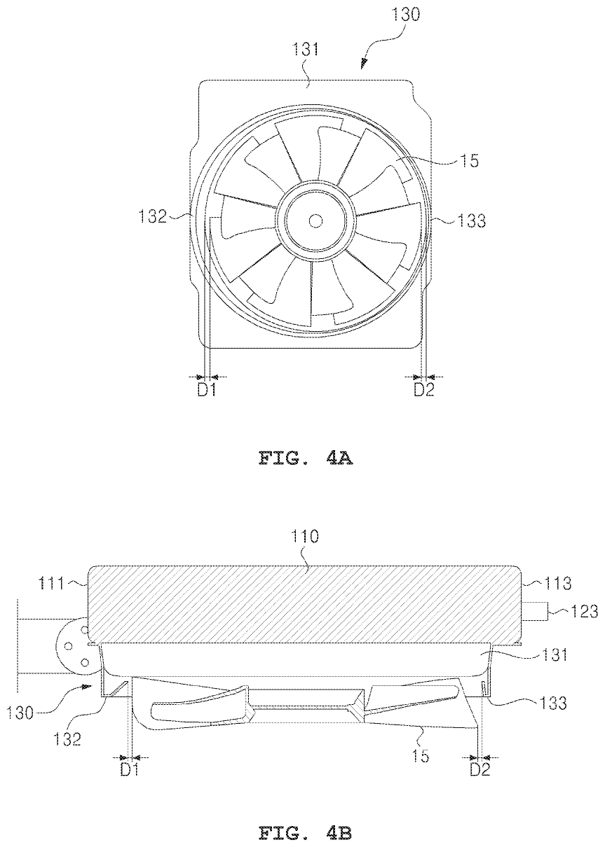

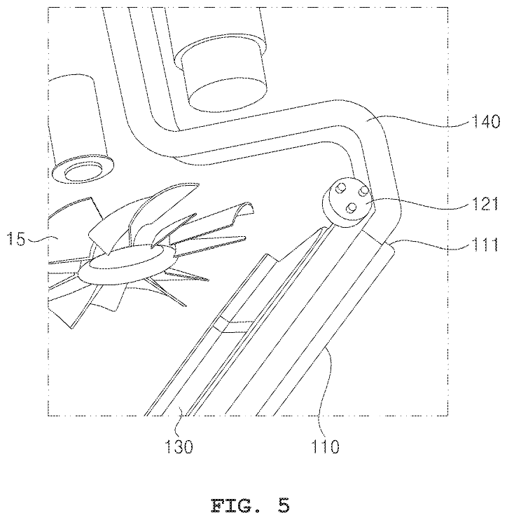

FIGS. 3A and 3B are plan views showing operational states of a cooling system according to the present disclosure. FIGS. 4A and 4B are views showing relation of arrangement between the cooling system and a fan in FIG. 3. FIG. 5 is a view showing relation of connection between the cooling system and a hose in FIG. 3.

Referring to FIGS. 3 to 5, a cooling system 100 according to the present disclosure may include a cooling unit 110 performing a cooling function required for the engine room 12, and a coupling unit 120 rotatably coupling the cooling unit 110 to an inner side wall of the engine room 12.

The cooling unit 110 is an assembly of parts performing the cooling operation inside the engine room 12 for stable driving of the vehicle, and may include a radiator, an intercooler, an oil cooler, and the like. The parts constituting the cooling unit 110 may be stacked with each other or be arranged vertically or horizontally.

At this point, the radiator is configured to cool the engine coolant, and the engine coolant heated after cooling the engine may be re-cooled in the radiator and be returned to the engine. The intercooler may cool air sucked from the external space into the engine room 12. The oil cooler is configured to cool engine oil, and the heated engine oil may be re-cooled in the oil cooler and then be returned to the engine.

The coupling unit 120 is configured to allow the cooling unit 110 to be rotatably mounted to the inner side wall of the engine room 12, and may include a hinge part 121 and a locking part 123. The hinge part 121 is provided on a first side surface of the cooling unit 110, and may be rotatably coupled to one side wall of the engine room 12. FIGS. 3A and 4B are views showing mounting the hinge part 121 on one side wall of the engine room 12 through a first bracket 17. Otherwise, without using a separate bracket, the hinge part 121 may be directly coupled to the inner side wall of the engine room 12.

According to an embodiment, the hinge part 121 may limit a rotation range of the cooling unit 110 within a preset angular range.

Specifically, when the hinge part 121 is configured to rotate the cooling unit 110 within a very wide angular range, the cooling unit 110 may hit the engine room cover 11 to be damaged with excessive large rotation, and a hose 140 connected to the cooling unit 110 may be separated. On the other hand, when the rotatable angular range of the hinge part 121 is excessively narrow, even with the cooling unit 110 being rotated, it is difficult to perform maintenance, cleaning, or the like. Therefore, the rotation range of the cooling unit 110 through the hinge part 121 needs to be preset appropriately. For example, the hinge part 121 may limit the rotation range of the cooling unit 110 within a 45 degrees angular range.

The locking part 123 may be provided on a second side surface of the cooling unit 110, i.e., an opposite surface to the first side surface where the hinge part 121 is provided in the cooling unit 110, and the locking part 123 may be separably coupled to an inner side wall of the engine room 12. FIGS. 3A and 3B show mounting the locking part 123 on one side wall of the engine room 12 through a second bracket 18. Otherwise, the locking part 123 may be directly coupled to the inner side wall of the engine room 12 to be separable therefrom without having a separate bracket.

Meanwhile, the locking part 123 may be easily coupled to the second bracket 18, and be easily separated from the second bracket 18. For example, the locking part 123 and the second bracket 18 may be composed of magnets that have opposite polarities to each other. In this case, as shown in FIG. 3A, in a state in which the locking part 123 is coupled to the second bracket 18, the cooling unit 110 can be prevented from being shaken or separated when the vehicle is driven. Furthermore, as shown in FIG. 3B, the operator can easily separate the locking part 123 from the second bracket 18 with a relatively small force applied thereto. Otherwise, the locking part 123 and the second bracket 18 may be shaped in latches or clips.

As described above, the cooling unit 110 may be mounted to the internal space of the engine room 12 by the coupling unit 120. At this point, the hinge part 121 is rotatably coupled to the inner side wall of the engine room 12, and the locking part 123 may be separably coupled to the inner side wall of the engine room 12. When the locking part 123 is separated from the inner side wall of the engine room 12, the cooling unit 110 may be rotated on the hinge part 121. In other words, the cooling unit 110 may be usually held to the engine room 12 by using the hinge part 121 and the locking part 123 and, in case of necessity, the cooling unit 110 is rotated on the hinge part 121 to expose parts located behind the cooling unit 110. This process is shown in both FIGS. 3A and 3B.

For convenience of description, a side surface where the hinge part 121 is provided in the cooling unit 110 is called a first side surface 111, and a side surface where the locking part 123 is provide is called a second side surface 113. At this point, it is sufficient that the hinge part 121 and the locking part 123 are respectively provided at the first side surface 111 and the second side surface 113, and installation heights thereof may be appropriately adjusted as needed. For example, the hinge part 121 and the locking part 123 may be respectively provided a lower portion of the first side surface 111 and a lower portion of the second side surface 113, or at a middle height of the first side surface 111 and a middle height of the second side surface 113.

According to an embodiment, the cooling system 100 according to the present disclosure may include a shroud 130 for guiding air passing through the cooling unit 110 to a cooling fan 15. The shroud 130 is provided behind the cooling unit 110, and may cause a flow of air together with the cooling fan 15 to improve cooling efficiency of the cooling unit 110.

Meanwhile, in order to maximally ensure the internal space of the engine room 12, the cooling system 100 and the cooling fan 15 should be arranged to be as close to each other as possible. In some cases, a part of the cooling fan 15 may be inserted into the shroud 130. As described above, when a part of the cooling fan 15 is inserted into the shroud 130, the effect of inducing air can be maximized, and the cooling performance of the cooling system 100 can be improved.

For this coupling structure, the shroud 130 may include a body part 131 and a guide part 132, 133. Specifically, the body part 131 may induce air passing through the cooling unit 110 towards the cooling fan 15. The guide part 132, 133 protrudes along an outer circumferential surface of the body part 131, and a chamber 135 may be formed within the guide part 132, 133 and the chamber 135 is a space relatively lower than the guide part. A part of the cooling fan 15 may be received in the chamber 135.

However, the cooling unit 110 of the present disclosure is rotatable on the hinge part 121, whereas the cooling fan 15 may be in a fixed state. Therefore, when the cooling unit 110 is rotated, interference may occur between the guide part 132, 133 and the cooling fan 15. Specifically, it is highly likely that a first guide part 132 that is close to the hinge part 121, i.e., a rotating shaft, interferes with a blade of the cooling fan 15. In order to solve this problem, as a gap between the entire guide part 132, 133 and the cooling fan 15 is increased, a blowing effect through the cooling fan 15 can be reduced, resulting the performance degradation of the cooling system 100.

Therefore, as the present disclosure is designed such that a gap between the guide part 132, 133 and the cooling fan 15 is not constant in response to a direction, interference between the guide part 132, 133 and the cooling fan 15 is avoided while minimizing the deterioration of cooling performance. Specifically, a shape of the shroud 130 is designed such that a distance D1 between the first guide part 132 located in a direction of the hinge part 121 and a blade end of the cooling fan 15 is larger than a distance D2 between a second guide part 133 located in a direction of the locking part 123 and a blade end of the cooling fan 15 (D1>D2). Accordingly, the cooling efficiency reduction degradation can be minimized while preventing interference during rotation of the cooling unit 110.

Meanwhile, the engine coolant, the engine oil, etc. heated in the engine may be cooled in a process of passing through the cooling unit 110. Therefore, a delivery passage for the engine coolant, the engine oil, etc. is required between the engine and the cooling unit 110, and in the present disclosure, the delivery passage will be called the hose 140. In other words, the heated engine coolant and the heated engine oil may be supplied from the engine to the cooling unit 110 through the hose 140, and be cooled in the cooling unit 110 and then be returned to the engine through the hose 140 again.

According to an embodiment, the hose 140 may be connected to the cooling unit 110 in a direction of the first side surface 111 of the cooling unit 110. This structure is shown in FIG. 5.

When the cooling unit 110 is rotated, the second side surface 113 with the locking part 123 may be completely spaced apart from the inner side wall of the engine room 12. Therefore, when the hose 140 is connected to the cooling unit 110 in a direction of the second side surface 113, there is a risk that the hose 140 is separated from the cooling unit 110 when the cooling unit 110 is rotated. Accordingly, in the present disclosure, as the hose 140 is connected to the cooling unit 110 in the direction of the first side surface 111 of the cooling unit 110, even when the cooling unit 110 is rotated, the hose 140 is prevented from being separated and is maintained in the coupled state.

Furthermore, when a last end of the hose 140 is made of a flexible material such as rubber, and the like, the hose 140 can be complemented prevented from being separated when the cooling unit 110 is rotated.

As described above, the cooling system of an agricultural work vehicle according to the present disclosure may be rotatably installed in the engine room 12. Therefore, in case of necessity, parts located behind the cooling unit 110 can be easily repaired and replaced by rotating the cooling unit 110, and the internal space of the engine room 12 can be further easily cleaned.

At this point, the distance between the guide part 132 of the shroud 130 and the cooling fan 15 in the direction of the hinge part 121, i.e., a rotating shaft, is increased, so that interference can be prevented from occurring when the cooling unit 110 is rotated. Furthermore, the hose 140 is also connected to the cooling unit 110 in the direction of the hinge part 121 so that the hose 140 can be prevented from being separated when the cooling unit 110 is rotated. Accordingly, the cooling system 100 can be rotated stably.

Although the preferred embodiments of the present disclosure have been disclosed for illustrative purposes, those skilled in the art will appreciate that various modifications, additions and substitutions are possible, without departing from the scope and spirit of the present disclosure as disclosed in the accompanying claims.

What is claimed is:

1. A cooling system of an agricultural work vehicle, the cooling system comprising:
a cooling unit comprising a radiator and configured to perform cooling operation; and
a coupling unit rotatably coupling the cooling unit to an inner side wall of an engine room.

2. The cooling system of claim 1, wherein the coupling unit comprises:
a hinge part provided on a first side surface of the cooling unit and rotatably coupled to a first inner side wall of the engine room; and
a locking part provided on a second side surface of the cooling unit and separably coupled to a second inner side wall of the engine room,
wherein when the locking part is separated from the second inner side wall of the engine room, the cooling unit is rotatable on the hinge part.

3. The cooling system of claim 2, wherein the hinge part limits a rotation range of the cooling unit within a preset angular range.

4. The cooling system of claim 2, wherein the locking part is separably coupled to the second inner side wall of the engine room by using a magnet.

5. The cooling system of claim 2, further comprising:
a shroud configured to guide air introduced into the cooling unit towards a cooling fan,
wherein the shroud comprises:
a body part configured to induce the air passing through the cooling unit towards the cooling fan; and
a guide part protruding along an outer circumferential surface of the body part and forming a space in which a part of the cooling fan is received.

6. The cooling system of claim 5, wherein a gap between the guide part and the cooling fan in a direction of the first side surface of the cooling unit is provided larger than a gap between the guide part and the cooling fan in a direction of the second side surface of the cooling unit.

7. The cooling system of claim 2, further comprising:
a hose configured to supply a heated engine coolant to the radiator, wherein the hose is connected to the radiator in a direction of the first side surface of the cooling unit.

8. The cooling system of claim 7, wherein a last end of the hose connected to the radiator is made of a flexible material.

9. A cooling system of an agricultural work vehicle, the cooling system comprising:
a cooling unit configured to cool an engine coolant and engine oil that are heated in an engine;
a hinge part provided at a first portion of the cooling unit and rotatably coupled to an inner side wall of the engine room;
a locking part provided at a second portion of the cooling unit and separably coupled to the inner side wall of the engine room; and
a hose delivering the engine coolant and the engine oil that are heated in the engine to the cooling unit, and returning the engine coolant and the engine oil cooled in the cooling unit to the engine,
wherein the hose is connected to the cooling unit in a direction of the first portion of the cooling unit where the hinge part is provided.

10. A cooling system of an agricultural work vehicle, the cooling system comprising:
a cooling unit configured to cool an engine coolant and engine oil that are heated in an engine;
a hinge part provided at a first portion of the cooling unit and rotatably coupled to an inner side wall of the engine room;
a locking part provided at a second portion of the cooling unit and separably coupled to the inner side wall of the engine room; and
a shroud provided between the cooling unit and a cooling fan to induce a flow of air, and in which a part of the cooling fan is received,
wherein a gap between the shroud and the cooling fan received in the shroud in a direction of the first portion of the cooling unit where the hinge part is provided is larger than a gap between the shroud and the cooling fan received therein in a direction of the second portion of the cooling unit where the locking part is provided.
